(19) United States
(12) Patent Application Publication
(10) Pub. No.: US 2017/0213302 A1
(43) Pub. Date: Jul. 27, 2017

(54) ENERGY SUPPLY AND DEMAND PLANNING DEVICE AND ENERGY SUPPLY AND DEMAND PLANNING PROGRAM

(71) Applicant: Mitsubishi Electric Corporation, Tokyo (JP)

(72) Inventors: Yutaka SAITO, Tokyo (JP); Hiroyuki HASHIMOTO, Tokyo (JP); Shoichi KITAMURA, Tokyo (JP); Hideaki HIRANO, Tokyo (JP); Kotaro SANAI, Tokyo (JP)

(73) Assignee: Mitsubishi Electric Corporation, Tokyo (JP)

(21) Appl. No.: 15/358,775

(22) Filed: Nov. 22, 2016

(30) Foreign Application Priority Data
Jan. 27, 2016 (JP) 2016-012969

(51) Int. Cl. G06Q 50/06; G06Q 10/06

(52) U.S. Cl. CPC G06Q 50/06; G06Q 10/06315

(57) ABSTRACT

An energy supply and demand planning device includes a database in which are stored data necessary for a power supply and demand plan and a fuel supply and demand plan, a power supply and demand planning unit that formulates a transaction plan for a power transaction market and a power generation plan, a fuel supply and demand planning unit that formulates a transaction plan for a fuel transaction market, a power generation revision plan, and a fuel tank operation plan, a data coordination unit that carries out an exchange of data between the power supply and demand planning unit and fuel supply and demand planning unit, and an operation control unit that carries out a determination of a start and convergence of operations in the power supply and demand planning unit and fuel supply and demand planning unit.

### BACKGROUND OF THE INVENTION

Field of the Invention

The present invention relates to an energy supply and demand planning device and energy supply and demand planning program that formulate an energy supply and demand plan including transaction plans for a power transaction market and fuel transaction market.

Description of the Background Art

There is an existing energy transaction support system whereby integrated plan support relating to energy transactions in power and fuel is carried out by formulating a transaction plan for a power transaction market so as to maximize power generating profit, determining an amount of fuel consumption commensurate with the transaction plan, then calculating a fuel transaction amount so as to maximize fuel transaction profit while securing the determined amount of fuel to be consumed (for example, refer to Patent Document 1).

### PATENT DOCUMENTS

Patent Document 1: JP-A-2007-58760

Generally, a supply and demand plan for correlated power and fuel is such that maximization of power generating profit is the object of a power supply and demand plan including a transaction in a power market, while maximization of fuel transaction profit is the object of a fuel supply and demand plan including a transaction in a fuel market, but as these involve differing objective functions, there is a problem in that discrepancies occur in the plans. In order to resolve this problem, the heretofore described Patent Document 1 is such that a power supply and demand plan is formulated first, after which a fuel supply and demand plan is formulated.

With this method, however, the power supply and demand plan is the main plan while the fuel supply and demand plan is the subordinate plan, because of which there is a problem in that there remains scope for increasing profit, particularly in the fuel supply and demand plan. This means that although profit of the power supply and demand plan is maximized, profit of the fuel supply and demand plan, which is restricted in order to realize maximized profit of the power supply and demand plan, is not necessarily maximized.

### SUMMARY OF THE INVENTION

The invention, having been contrived in order to resolve the heretofore described kinds of problem, has an object of converging energy supply and demand plans including transaction plans, thus maximizing total profit, by causing data to be mutually coordinated between a power supply and demand plan and a fuel supply and demand plan.

An energy supply and demand planning device according to an aspect of the invention is characterized by including a database in which are stored data necessary for a power supply and demand plan and a fuel supply and demand plan, a power supply and demand planning unit that formulates a transaction plan for a power transaction market and a power generation plan, a fuel supply and demand planning unit that formulates a transaction plan for a fuel transaction market, a power generation revision plan, and a fuel tank operation plan, a data coordination unit that carries out an exchange of data between the power supply and demand planning unit and fuel supply and demand planning unit, and an operation control unit that carries out a determination of a start and convergence of operations in the power supply and demand planning unit and fuel supply and demand planning unit.

According to the invention, a notable advantage is achieved in that energy supply and demand plans including transaction plans can be converged, thus maximizing total profit, by causing data to be mutually coordinated between a power supply and demand plan and fuel supply and demand plan that handle differing objective functions.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a relationship between power and fuel of an energy supplier according to a first embodiment of the invention;

FIG. 2 is a functional block diagram of an energy supply and demand planning device according to the first embodiment of the invention;

FIG. 3 is a flowchart showing a process procedure that causes compilation of an energy supply and demand plan according to the first embodiment of the invention to be executed;

FIG. 4 is a schematic diagram showing an energy flow according to the first embodiment of the invention;

FIG. 5 is a diagram representing as an image reserve power generation capacity and power generation reduction of the energy supply and demand planning device according to the first embodiment of the invention;

FIG. 6 is a diagram showing operation result output examples of the energy supply and demand planning device according to the first embodiment of the invention;

FIG. 7 is a functional block diagram of the energy supply and demand planning device according to a second embodiment of the invention; and

FIG. 8 is a flowchart showing an operational procedure that causes a compilation of an energy supply and demand plan according to the second embodiment to be executed.

### DETAILED DESCRIPTION OF THE INVENTION

### First Embodiment

Hereafter, the invention will be described with reference to the drawings, which are embodiments.

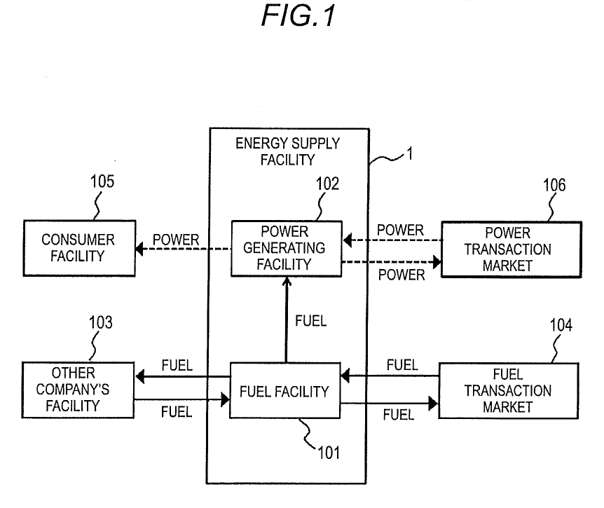

FIG. 1 is a schematic diagram showing a relationship between power and fuel of an energy supplier according to a first embodiment of the invention.

In the diagram, the energy supplier has an energy supply facility 1 formed of a fuel facility 101, wherein fuel is stored in a storage facility such as a tank, and a power generating facility 102. The fuel facility 101 supplies fuel for power generation to the power generating facility 102, purchases fuel from an other facility 103 via a fuel conveying system such as a fuel tanker or pipeline, and stocks the fuel, or sells the fuel to the other facility 103. Also, the fuel facility 101 purchases fuel in a fuel transaction market 104, and stocks or sells the fuel. Furthermore, the power generating facility 102 generates power by consuming the fuel supplied from the fuel facility 101, supplies power to a consumer facility 105, such as a factory or building, with which a power receiving contract has been made, and purchases or sells power in a power transaction market 106.

In the following description, fuel handled in the fuel facility 101 is assumed to be liquid natural gas (hereafter called LNG), and fuel handled in the power generating facility 102 is assumed to be LNG, coal, and oil.

That is, the power generating facility 102 generates power by consuming not only fuel (herein, LNG) supplied from the fuel facility 101 but also other fuel (coal, oil, or the like). Also, sale and purchase of fuel to and from another company carried out via a fuel conveying system such as a fuel tanker or pipeline is carried out in accordance with a transaction price and transaction amount determined by a bilateral contract entered into by the energy supplier and the other company. Furthermore, in the fuel transaction market 104, a multiple of businesses and consumers bid on the transaction price and transaction amount of the sale and purchase of fuel in a predetermined period, and the bids are gathered to determine the transaction price and transaction amount of fuel in each period.

By configuring in this way, a consumer such as a factory or building can enter into a power receiving contract with the energy supplier, and purchase power at a fixed price to an extent not exceeding the contracted amount of power.

Meanwhile, in the power transaction market 106, a multiple of businesses and consumers bid on the transaction price and transaction amount of the sale and purchase of power in a predetermined period, and the bids are gathered to determine the transaction price and transaction amount of power in each period.

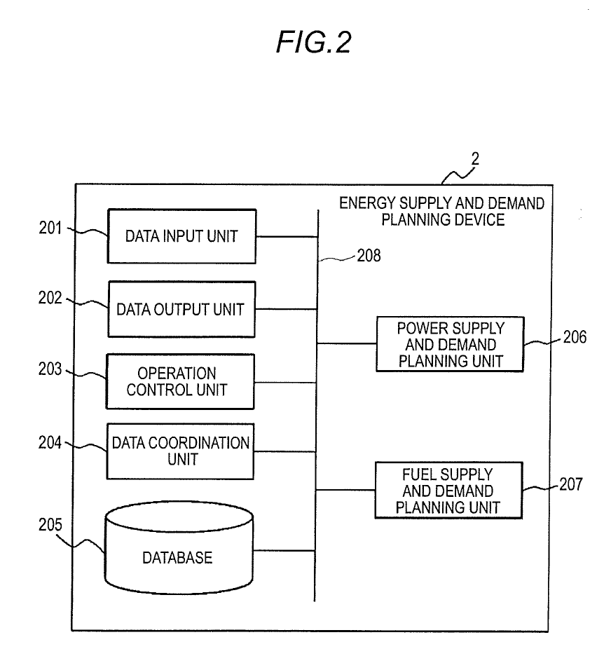

FIG. 2 shows a functional block of an energy supply and demand planning device according to the first embodiment of the invention, and in the drawing, an energy supply and demand planning device 2, which is a main portion of the invention, is provided in the energy supply facility 1 of the energy supplier.

The energy supply and demand planning device 2 has an object of formulating transaction plans for a power transaction market and fuel transaction market so as to maximize profit from an energy supply and demand plan, and is configured of a data input unit 201, a data output unit 202, an operation control unit 203, a data coordination unit 204, a database 205, a power supply and demand planning unit 206, and a fuel supply and demand planning unit 207. These components are connected to each other so as to be capable of exchanging data by a communication system 208 formed of a network facility such as an optical line. Also, these components are configured of a computer, and have the following functions.

Firstly, the data input unit 201 is a function for inputting information necessary for an energy supply and demand plan and includes, for example, a monitor, a keyboard, and a mouse, wherein data necessary for each component are input by a user. By adopting a configuration such that the data input unit 201 further includes a network interface device, for example, data received by carrying out communication with an external device can be imported.

The data output unit 202 is a function for outputting an energy supply and demand plan operation result, and includes, for example, a display device, a printing device, and a magnetic disk device. Also, by adopting a configuration such that the data output unit 202 further includes a network interface device, in the same way as the data input unit 201, information on an energy supply and demand plan operation result can be transmitted as an output to an external device.

The operation control unit 203 is a function for controlling an operation of an energy supply and demand plan, includes a central processing unit (hereafter called a CPU) and dynamic random access memory (hereafter called a DRAM) in addition to including, for example, a monitor, a keyboard, and a mouse, and when an operation start command is input, the operation control unit 203 transmits an operation start command to the power supply and demand planning unit 206 and fuel supply and demand planning unit 207, and transmits a command relating to data coordination to the data coordination unit 204. Also, the operation control unit 203 determines whether or not operations in the power supply and demand planning unit 206 and fuel supply and demand planning unit 207 have converged, transmits a command relating to ending operations when the operations have converged, and transmits a command relating to continuing operations when the operations have not converged. Furthermore, the operation control unit 203 manages the number of times an operation is repeated, and is configured so as to initialize the number of repetitions at 1 when receiving an operation start command, and to increase the number of operation repetitions by one when the operation is continued. Also, by adopting a configuration such that the operation control unit 203 further includes a network interface device, for example, an energy supply and demand plan operation can be controlled with the addition of information received by carrying out communication with an external device.

The data coordination unit 204 is a function that coordinates data necessary for an energy supply and demand plan operation, includes, for example, a CPU and DRAM, calculates a power generating fuel consumption plan, reserve power generation capacity, a power generation reduction, a power generation unit price, and the like, from a transaction plan for a power transaction market and a power generation plan, which are results calculated in the power supply and demand planning unit 206, and transmits these data to the fuel supply and demand planning unit 207. Also, the data coordination unit 204 calculates a tank fuel unit price, a tank fuel heat quantity, upper and lower limits of fuel consumption restriction, and the like, from a transaction plan for a fuel transaction market, a power generation revision plan, and a fuel tank operation plan, which are results calculated in the fuel supply and demand planning unit 207, and transmits these data to the power supply and demand planning unit 206.

The database 205 is a storage device that stores data necessary for an energy supply and demand plan operation, and is realized by, for example, a magnetic disk device. Various kinds of data, such as power demand, a fuel unit price, a fuel heat quantity, power generating characteristics of a power generating facility, upper and lower limits of power generation in the power generating facility, upper and lower limits of power generation change in the power generating facility, a power market price, upper and lower limits of transaction amount in a power transaction market, a transaction plan according to a bilateral fuel contract, a ship assignment plan, upper and lower limits of pipeline conveying, a fuel market price, upper and lower limits of transaction amount in a fuel transaction market, a fuel market heat quantity, an initial tank fuel unit price, an initial tank fuel heat quantity, an initial tank volume, a final tank volume, and upper and lower tank capacity limits, are stored in the database 205.

The power supply and demand planning unit 206 is a function that carries out a power supply and demand plan operation of an energy supply and demand plan, includes, for example, a CPU and DRAM, receives a command from the operation control unit 203 and, with power demand, a fuel unit price, a fuel heat quantity, power generating characteristics of a power generating facility, upper and lower limits of power generation in the power generating facility, upper and lower limits of power generation change in the power generating facility, a power market price, upper and lower limits of transaction amount in a power transaction market, a tank fuel unit price, a tank fuel heat quantity, upper and lower limits of fuel consumption restriction, and the like, as input data, outputs a transaction plan and power generation plan for the power transaction market so that power demand is satisfied and profit is maximized.

The fuel supply and demand planning unit 207 is a function that carries out a fuel supply and demand plan operation of an energy supply and demand plan, includes, for example, a CPU and DRAM, receives a command from the operation control unit 203 and, with a transaction plan according to a bilateral fuel contract, a ship assignment plan, upper and lower limits of pipeline conveying, a fuel market price, upper and lower limits of transaction amount in a fuel transaction market, a fuel market heat quantity, an initial tank fuel unit price, an initial tank fuel heat quantity, an initial tank volume, a final tank volume, upper and lower tank capacity limits, a power generating fuel consumption plan, reserve power generation capacity, a power generation reduction, a power generation unit price, a power market unit price, and the like, as input data, outputs a transaction plan for the fuel transaction market, a power generation revision plan, and a fuel tank operation plan so that the transaction amount according to the bilateral fuel contract is satisfied, and profit is maximized.

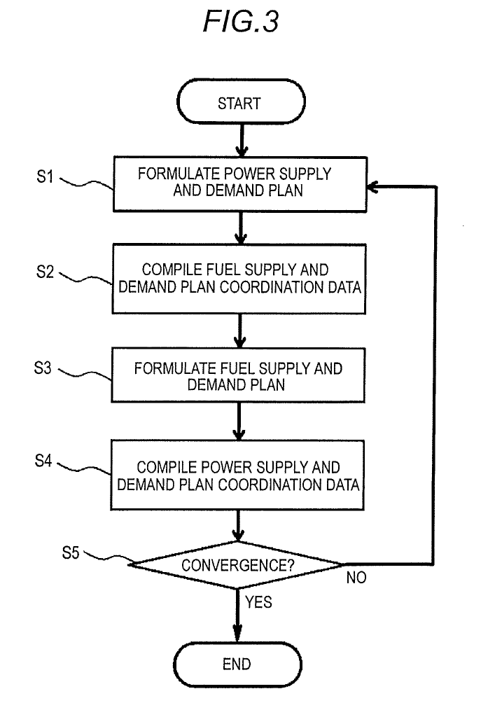

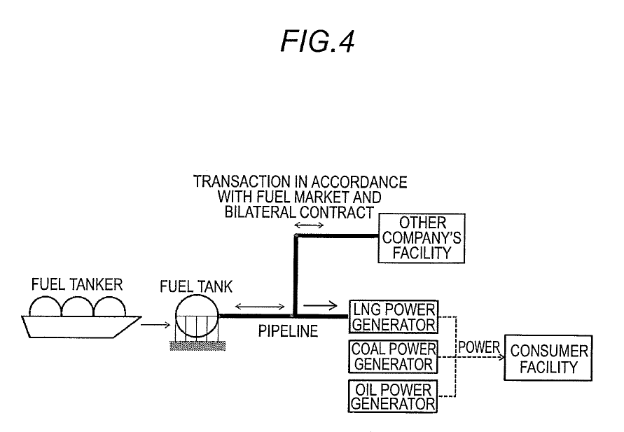

Next, based on FIGS. 3 and 4, a description will be given of an operation of each unit in the first embodiment configured as heretofore described.

FIG. 3 is a flowchart showing a process procedure that causes compilation of an energy supply and demand plan according to the first embodiment of the invention to be executed by a computer, while FIG. 4 is a schematic diagram showing an energy flow according to the first embodiment of the invention.

Herein, in order to simplify the description, it is assumed that a power generating facility has one power generator having LNG as fuel, one power generator having coal as fuel, and one power generator having oil as fuel, as shown in FIG. 4. Also, it is assumed that a fuel facility has one fuel tank, LNG is supplied to the fuel tank from a fuel tanker, and LNG is conveyed from the fuel tank to the power generating facility via a pipeline.

Firstly, setting of various kinds of data is carried out before an operational processing is started. Specifically, various kinds of data such as power demand, a fuel unit price, a fuel heat quantity, power generating characteristics of the power generating facility, upper and lower limits of power generation in the power generating facility, upper and lower limits of power generation change in the power generating facility, a power market price, upper and lower limits of transaction amount in a power transaction market, a transaction plan according to a bilateral fuel contract, a ship assignment plan, upper and lower limits of pipeline conveying, a fuel market price, upper and lower limits of transaction amount in a fuel transaction market, a fuel market heat quantity, an initial tank fuel unit price, an initial tank fuel heat quantity, an initial tank volume, a final tank volume, and upper and lower tank capacity limits are input by the data input unit 201. Note that one year's worth of input data relating to a temporal sequence are assumed to be input with, for example, 30 minute intervals in accordance with the temporal sequence.

Specific examples of each kind of data input here are as follows.

Power demand (Edem) indicates the power the energy supplier has to supply to the consumer in each period.

Power generating characteristics of a power generating facility (a power generating characteristic of an LNG power generator is taken to be fLNG, a power generating characteristic of a coal power generator is taken to be fCoal, and a power generating characteristic of an oil power generator is taken to be fOil) are set in each power generating facility, are characteristics indicating a relationship between an amount of heat supplied (=fuel consumption×fuel heat quantity) and an amount of power generation in each power generating facility, and can be expressed using a numerical formula, a graph, or the like. Herein, fuel consumption of an LNG power generator is taken to be Ggen_LNG, fuel consumption of a coal power generator is taken to be GCoal, and fuel consumption of an oil power generator is taken to be GOil.

A fuel unit price is a value used for calculating power generating profit, and is set for each kind of fuel. Herein, the fuel unit price of LNG supplied to an LNG power generator is taken to be a tank fuel unit price Ptank_LNG, the fuel unit price of coal is taken to be PCoal, and the fuel unit price of oil is taken to be POil.

A fuel heat quantity is a value used for calculating an amount of power generation in a power generating facility, and is set for each kind of fuel. Herein, a fuel heat quantity of LNG supplied to an LNG power generator is taken to be a tank fuel heat amount Htank_LNG, a fuel heat quantity of coal is taken to be HCoal, and a fuel heat quantity of oil is taken to be HOil.

Upper and lower limits of power generation in a power generating facility (upper and lower limits of power generation of an LNG power generator are taken to be ELNG_min and ELNG_max, upper and lower limits of power generation of a coal power generator are taken to be ECoal_min and ECoal_max, and upper and lower limits of power generation of an oil power generator are taken to be EOil_min and EOil_max) are lower limits and upper limits for expressing a range over which each power generating facility can generate power.

Upper and lower limits of power generation change in a power generating facility (upper and lower limits of power generation change of an LNG power generator are taken to be VLNG_min and VLNG_max, upper and lower limits of power generation change of a coal power generator are taken to be VCoal_min and VCoal_max, and upper and lower limits of power generation change of an oil power generator are taken to be VOil_min and VOil_max) are lower limits and upper limits for expressing a range over which each power generation in each power generating facility can change from one period to the next predetermined period.

A power market price (taken to be Ptrade_ele) is a price in each period of a power market in which the energy supplier conducts bidding.

Upper and lower limits of transaction amount (taken to be Etrade_min and Etrade_max) in a power transaction market are a lower limit and upper limit for expressing a range of a power market transaction amount.

A transaction plan according to a bilateral fuel contract includes a transaction amount (taken to be Gcont_LNG), heat quantity (taken to be Hcont_LNG), and price (taken to be Pcont_LNG) of fuel determined in advance in a contract between the energy supplier and another company. Herein, a transaction in accordance with a bilateral fuel contract is assumed to be a transaction via a pipeline.

A ship assignment plan includes an amount supplied (taken to be Gship_LNG), heat quantity (taken to be Hship_LNG), and price (taken to be Pship_LNG) in each period of a portion conveyed by fuel tanker of the fuel supplied by the energy supplier to the fuel facility 101.

Upper and lower limits of pipeline conveying (taken to be Gpipe_LNG_min and Gpipe_LNG_max) are a lower limit and upper limit for expressing a range over which the fuel facility 101 can convey via a pipeline.

A fuel market price (taken to be Ptrade_LNG) is a price in each period of a fuel market in which the energy supplier conducts bidding. A fuel market heat quantity (taken to be Htrade_LNG) is a heat quantity in each period of a fuel market in which the energy supplier conducts bidding.

Upper and lower limits of transaction amount in the fuel transaction market 104 (taken to be Gtrade_LNG_min and Gtrade_LNG_max) are a lower limit and upper limit for expressing a range of a fuel market transaction amount.

An initial tank fuel unit price (taken to be Ptank_LNG_start) is an initial unit price in a plan period of fuel stored in a tank of the fuel facility 101.

An initial tank fuel heat quantity (taken to be Htank_LNG_start) is an initial heat quantity in a plan period of fuel stored in a tank of the fuel facility 101.

An initial tank volume (taken to be Gtank_LNG_start) is an initial volume in a plan period of fuel stored in a tank of the fuel facility 101.

A final tank volume (taken to be Gtank_LNG_end) is a volume that should be stored in a tank of the fuel facility 101 at a final stage of a plan period.

Upper and lower tank capacity limits (taken to be Gtank_LNG_min and Gtank_LNG_max) are a lower limit and upper limit for indicating a range of an amount of fuel a tank of the fuel facility 101 can store.

Data setting before an operational processing is started is such that a tank fuel heat quantity and tank fuel unit price in each period are input as constant values (equivalent to an initial tank fuel heat quantity and initial tank fuel unit price). Also, a determination value 1 (D1) and determination value 2 (D2) used in determining convergence in the operation control unit 203 are input.

The heretofore described kinds of data input by the data input unit 201 are stored in the database 205. Subsequently, an operational processing is started by an operation start command being input into the operation control unit 203.

Next, based on FIG. 3, an operation of the energy supply and demand planning device 2 will be described.

Firstly, on an operation start command input into the operation control unit 203 being received, the operation start command is transmitted to the energy supply and demand planning unit 206, and an energy supply and demand plan is formulated (step S1).

Specifically, the power supply and demand planning unit 206, with power demand, a fuel unit price, a fuel heat quantity, power generating characteristics of a power generating facility, upper and lower limits of power generation in the power generating facility, upper and lower limits of power generation change in the power generating facility, a power market price, a tank fuel unit price, a tank fuel heat quantity, upper and lower limits of fuel consumption restriction, and the like, as input data, outputs a transaction plan and power generation plan for a power transaction market so that power demand is satisfied and profit is maximized.

Also, an optimization problem including the following kinds of power generating characteristic expression, objective function, and restriction condition is compiled in advance in the energy supply and demand planning unit 206.

Herein, the power generating characteristic expressions are set in each power generating facility, and can be expressed as in, for example, Expressions 1 to 3.

$$\begin{matrix}Math . 1 & \\ Math . 1 Power Generating Characteristic \\ Expressions & \\ {G}_{gen\_LNG} ( t ) = \frac{{f}_{LNG} ( {E}_{LNG} ( t ) )}{{H}_{tank\_LNG} ( t )} & Expression 1 \\ {G}_{Coal} ( t ) = \frac{{f}_{Coal} ( {E}_{Coal} ( t ) )}{{H}_{Coal} ( t )} & Expression 2 \\ {G}_{Oil} ( t ) = \frac{{f}_{Oil} ( {E}_{Oil} ( t ) )}{{H}_{Oil} ( t )} & Expression 3\end{matrix}$$

t is an index that represents each period.

Also, an objective function has maximization of profit as an object of an optimization calculation, with expenditure on fuel consumed in power generation and income or expenditure resulting from transaction in a power transaction market as total profit, and the objective function can be expressed as in, for example, Expression 4.

$$\begin{matrix} Math . 2 & \\ Math . 2 Objective Function & \\ max . {\sum }_{t} \{ {P}_{tank\_LNG} ( t ) \times {G}_{gen\_LNG} ( t ) + {P}_{Coal} ( t ) \times {G}_{Coal} ( t ) + {P}_{Oil} ( t ) \times {G}_{Oil} ( t ) + {P}_{trade\_ele} ( t ) \times {E}_{trade} ( t ) \} & Expression 4\end{matrix}$$

Furthermore, a range of the amount of power generation that can be generated (power generation restrictions) in each power generator of a power generating facility in each period (the amount of power generation in an LNG power generator is taken to be ELNG, the amount of power generation in a coal power generator is taken to be ECoal, and the amount of power generation in an oil power generator is taken to be EOil), a range over which the amount of power generation in a power generating facility can change from one period to the next period (power generation change restrictions), a range of an amount of transactions that can be carried out (taken to be Etrade) in a power transaction market in each period (power transaction market transaction amount restrictions), and a range of a total amount of fuel that can be consumed (fuel consumption restrictions) from one predetermined period (taken to be tstart (s)) to a subsequent predetermined period (taken to be tend (s)), are set as restriction conditions, and an expression for achieving balance between power demand and supply (a power supply and demand balance expression) is set. Note that a lower limit of the fuel consumption restrictions is taken to be Gcons_LNG_min, and an upper limit is taken to be Gcons_LNG_max.

Herein, the power generation restrictions can be expressed as in, for example, Expressions 5 to 7.

Math. 3

Math. 3 Restriction Conditions

E_{LNG}_{_}ₘᵢₙ(t)≦E_{LNG}(t)≦E_{LNG}_{_}ₘₐₓ(t) Expression 5

E_{Coal}_{_}ₘᵢₙ(t)≦E_{Coal}(t)≦E_{Coal}_{_}ₘₐₓ(t) Expression 6

E_{Oil}_{_}ₘᵢₙ(t)≦E_{Oil}(t)≦E_{Oil}_{_}ₘₐₓ(t) Expression 7

Also, the power generation change restrictions can be expressed as in, for example, Expressions 8 to 10.

Math. 4

Math. 4 Restriction Conditions

V_{LNG}_{_}ₘᵢₙ(t)≦(E_{LNG}(t)−E_{LNG}(t−1))≦V_{LNG}_{_}ₘₐₓ(t) Expression 8

V_{Coal}_{_}ₘᵢₙ(t)≦(E_{Coal}(t)−E_{Coal}(t−1))≦V_{Coal}_{_}ₘₐₓ(t) Expression 9

V_{Oil}_{_}ₘᵢₙ(t)≦(E_{Oil}(t)−E_{Oil}(t−1))≦V_{Oil}_{_}ₘₐₓ(t) Expression 10

Furthermore, the power transaction market transaction amount restrictions can be expressed as in, for example, Expression 11, and the fuel consumption restrictions and power supply and demand balance can be expressed as in, for example, Expressions 12 and 13 respectively.

Math. 5

Math. 5 Restriction Conditions

E_{trade}_{_}ₘᵢₙ(t)≦E_{trade}(t)≦E_{trade}_{_}ₘₐₓ(t) Expression 11

G_{cons}_{_}_{LNG}_{_}ₘᵢₙ(s)≦Σₜ₌ₜ_{ₛₜₐᵣₜ}₍ₛ₎^{t}^{_{end}}^{(s)}G_{gen}_{_}_{LNG}(t)≦G_{cons}_{_}_{LNG}_{_}ₘₐₓ(s). Expression 12

E_{LNG}(t)+E_{Coal}(t)+E_{Oil}(t)+E_{trade}(t)=E_{dem}(t). Expression 13

s is an index that identifies each fuel consumption restriction.

Also, as an optimization method for solving the optimization problem, an optimization method such as linear programming is applied when the optimization problem is a linear programming problem, an optimization method such as mixed integer linear programming is applied when the optimization problem is a mixed integer linear programming problem including an integer, an optimization method such as quadratic programming is applied when the optimization problem is a quadratic programming problem, and an optimization method such as a metaheuristics is applied when the optimization problem is a non-linear programming problem.

Parameters to be input into the optimization problem are calculated based on the input data set in the data input unit 201 in the way heretofore described, the parameters are input into the optimization problem, and an optimal solution whereby profit is maximized, that is, a transaction plan for a power transaction market and a power generation plan, is obtained using an optimization method.

Next, in step S2, fuel supply and demand plan coordination data are compiled. Specifically, a power generating fuel consumption plan, reserve power generation capacity, a power generation reduction, a power generation unit price, and the like, are calculated in the data coordination unit 204 based on a transaction plan for a power transaction market and a power generation plan, which are results calculated in the power supply and demand planning unit 206, and these data are transmitted to the fuel supply and demand planning unit 207.

Also, the data coordination unit 204 extracts the amount of power generation in the LNG power generator in each period from the power generation plan, back calculates the amount of fuel consumed in the LNG power generator in each period based on the LNG power generator power generating characteristics stored in the database 205, and compiles a power generating fuel consumption plan. A formula for calculating the power generating fuel consumption can be expressed as in, for example, Expression 14.

$$\begin{matrix}Math . 6 & \\ Math . 6 Power Generating Fuel Consumption \\ Plan Calculation Formula & \\ {G}_{gen\_LNG} ( t ) = \frac{{f}_{LNG} ( {E}_{LNG} ( t ) )}{{H}_{tank - LNG} ( t )} & Expression 14\end{matrix}$$

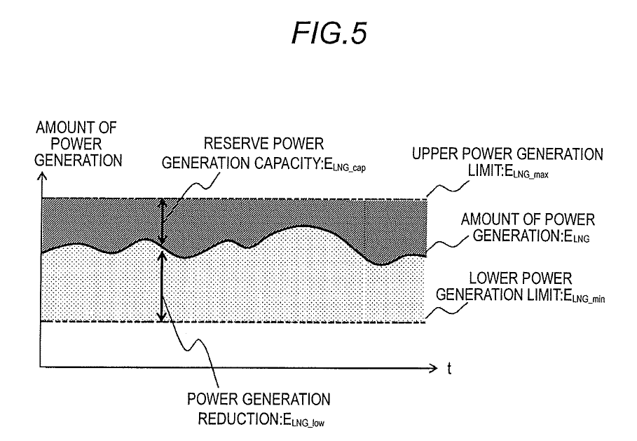

FIG. 5 is a diagram representing as an image reserve power generation capacity and power generation reduction of the energy supply and demand planning device according to the first embodiment of the invention.

In the diagram, the amount of power generation in the LNG power generator in each period is extracted from the power generation plan, and reserve power generation capacity (taken to be ELNG_cap) and power generation reduction (taken to be ELNG_low) in the LNG power generator in each period are calculated from the LNG power generator upper and lower power generation limits stored in the database 205. A formula for calculating the reserve power generation capacity can be expressed as in, for example, Expression 15a. A formula for calculating the power generation reduction can be expressed as in, for example, Expression 15b.

Math. 7

### Math. 7 Reserve Power Generation Capacity Calculation Formula

E_{LNG}_{_}_{cap}(t)=E_{LNG}_{_}ₘₐₓ−E_{LNG}(t) Expression 15a

Power Generation Reduction Calculation Formula

E_{LNG}_{_}_{low}(t)=E_{LNG}(t)−E_{LNG}_{_}ₘᵢₙ Expression 15b

Also, the amount of power generation in the LNG power generator in each period is extracted from the power generation plan, and with regard to an LNG power generator indicating an intermediate amount of power generation without reaching the upper or lower power generation limit, a power generation unit price (taken to be Pgen_LNG) for the LNG power generator in each period is calculated from the LNG power generator power generating characteristics stored in the database 205, tank fuel heat quantity, and tank fuel unit price. Herein, as it is assumed that there is one LNG power generator, the power generation unit price is calculated for this LNG power generator. A formula for calculating the power generation unit price can be expressed as in, for example, Expression 16.

$$\begin{matrix}Math . 8 & \\ Math . 8 Power Generation Unit Price \\ Calculation Formula & \\ {P}_{gen - LNG} ( t ) = \frac{{P}_{tank\_LNG} ( t ) \times {G}_{gen\_LNG} ( t )}{{E}_{LNG} ( t )} & Expression 16\end{matrix}$$

The reserve power generation capacity, power generation reduction, and power generation unit price are used as the reserve power generation capacity, power generation reduction, and power generation unit price when formulating a power generation revision plan in the fuel supply and demand planning unit 207.

Next, in step S3, a fuel supply and demand plan is formulated.

Specifically, the fuel supply and demand planning unit 207, with a transaction plan according to a bilateral fuel contract, a ship assignment plan, upper and lower limits of pipeline conveying, a fuel market price, upper and lower limits of transaction amount in a fuel transaction market, a fuel market heat quantity, an initial tank fuel unit price, an initial tank fuel heat quantity, an initial tank volume, a final tank volume, upper and lower tank capacity limits, a power generation plan, a power generating fuel consumption plan, reserve power generation capacity, a power generation reduction, a power generation unit price, a power market unit price, and the like, as input data, outputs a transaction plan for the fuel transaction market, a power generation revision plan, and a fuel tank operation plan so that the transaction amount according to the bilateral fuel contract is satisfied, and profit is maximized.

An optimization problem including the following kinds of calculation formula, objective function, and restriction condition is compiled in advance in the fuel supply and demand planning unit 207.

A calculation formula that calculates a power generation revision fuel consumption amount (taken to be Ggen_LNG_plus) necessary for power generation revision is set as a calculation formula. A formula for calculating the power generation revision fuel consumption amount can be expressed as in, for example, Expression 17. Furthermore, with regard to tank volume (taken to be Gtank_LNG), a calculation formula that calculates tank volume in a subsequent period from the tank volume in a certain period and the amount of fuel consumed is set. A formula for calculating tank volume in a subsequent period can be expressed as in, for example, Expression 18.

$$\begin{matrix} Math . 9 & \\ Math . 9 Power Generation Revision Fuel \\ Consumption Amount Calculation Formula & \\ {G}_{gen\_LNG \_plus} ( t ) = \frac{{f}_{LNG} ( {E}_{LNG} ( t ) + {E}_{LNG - plus} ( t ) )}{{H}_{tank - LNG} ( t )} - {G}_{gen\_LNG} ( t ) & Expression 17\end{matrix}$$

Tank Volume Calculation Formula

Gₜₐₙₖ_{_}_{LNG}(t+1)=Gₜₐₙₖ_{_}_{LNG}(t)−G_{cont}_{_}_{LNG}(t)−G_{trade}_{_}_{LNG}(t)−G_{gen}_{_}_{LNG}(t)−G_{gen}_{_}_{LNG}_{_}ₚₗᵤₛ(t)+Gₛₕᵢₚ_{_}_{LNG}(t) Expression 18

Also, an objective function has maximization of profit as an object of an optimization calculation, with a balance of payments with respect to sale and purchase of power in a power market resulting from power generation revision, a balance of payments with respect to fuel consumption resulting from power generation revision, and income or expenditure resulting from transaction in a fuel transaction market as total profit. The objective function can be expressed as in, for example, Expression 19.

$$\begin{matrix} Math . 10 & \\ Math . 10 Objective Function & \\ max . {\sum }_{t} \{ {P}_{trade - ele} ( t ) \times {E}_{LNG - plus} ( t ) - {P}_{tank\_LNG} ( t ) \times {G}_{gen - LNG - plus} ( t ) + ( {P}_{trade\_LNG} ( t ) - {P}_{tank - LNG} ( t ) ) \times {G}_{trade - LNG} ( t ) \} & Expression 19\end{matrix}$$

Furthermore, a range over which power generation can be revised (taken to be ELNG_plus) in each period (power generation revision restrictions), a range over which the amount of power generation in a power generating facility can change from one period to the next period taking the amount of power generation revision into consideration (power generation change restrictions taking the amount of power generation revision into consideration), a range of an amount of transactions that can be carried out (taken to be Gtrade_LNG) in a fuel transaction market in each period (fuel transaction market transaction amount restrictions), a range of an amount of fuel that can be conveyed by pipeline (fuel conveying amount restrictions), and a range over which tank volume can vary (tank volume restrictions), are set as restriction conditions.

Herein, the power generation revision restrictions can be expressed as in, for example, Expression 20. The power generation change restrictions taking the amount of power generation revision into consideration can be expressed as in, for example, Expression 21. The fuel transaction market transaction amount restrictions can be expressed as in, for example, Expression 22. The fuel conveying amount restrictions can be expressed as in, for example, Expression 23. The tank volume restrictions can be expressed as in, for example, Expression 24.

Math. 11

### Math. 11 Restriction Conditions

−E_{LNG}_{_}_{low}(t)≦E_{LNG}_{_}ₚₗᵤₛ(t)≦min{E_{LNG}_{_}_{cap}(t)E_{trade}(t)−E_{trade}_{_}ₘᵢₙ(t)} Expression 20

V_{LNG}_{_}ₘᵢₙ(t)≦(E_{LNG}(t)+E_{LNG}_{_}ₚₗᵤₛ(t)−E_{LNG}(t−1)−E_{LNG}_{_}ₚₗᵤₛ(t−1))≦V_{LNG}_{_}ₘₐₓ(t) Expression 21

G_{trade}_{_}_{LNG}_{_}ₘᵢₙ(t)≦G_{trade}_{_}_{LNG}(t)≦G_{trade}_{_}_{LNG}_{_}ₘₐₓ(t) Expression 22

Gₚᵢₚₑ_{_}_{LNG}_{_}ₘᵢₙ(t)≦G_{trade}_{_}_{LNG}(t)+G_{gen}_{_}_{LNG}(t)+G_{gen}_{_}_{LNG}_{_}ₚₗᵤₛ(t)≦Gₚᵢₚₑ_{_}_{LNG}_{_}ₘₐₓ(t) Expression 23

Gₜₐₙₖ_{_}_{LNG}_{_}ₘᵢₙ(t)≦Gₜₐₙₖ(t)≦Gₜₐₙₖ_{_}_{LNG}_{_}ₘₐₓ(t) Expression 24

Also, as an optimization method for solving the optimization problem, an optimization method such as linear programming is applied when the optimization problem is a linear programming problem, an optimization method such as mixed integer linear programming is applied when the optimization problem is a mixed integer linear programming problem including an integer, an optimization method such as quadratic programming is applied when the optimization problem is a quadratic programming problem, and an optimization method such as a metaheuristics is applied when the optimization problem is a non-linear programming problem.

Next, in step S4, power supply and demand plan coordination data are compiled.

Specifically, a tank fuel unit price, a tank fuel heat quantity, upper and lower limits of fuel consumption restrictions, and the like, are calculated in the data coordination unit 204 from a transaction plan for a fuel transaction market, a power generation revision plan, and a fuel tank operation plan, which are results calculated in the fuel supply and demand planning unit 207, and these data are transmitted to the power supply and demand planning unit 206.

The data coordination unit 204 extracts the amount of transaction in a fuel transaction market in each period from the transaction plan for a fuel transaction market, extracts the tank volume and amount of fuel consumed in each period from the fuel tank operation plan, and calculates the tank fuel heat quantity in each period from a bilateral fuel transaction amount according to a bilateral fuel contract, ship assignment plan, fuel market heat quantity, and initial tank fuel heat quantity stored in the database 205. A formula for calculating the tank fuel heat quantity can be expressed as in, for example, Expression 25. Note that an amount purchased of the amount of transaction in a fuel transaction market is taken to be Gtrade_LNG_buy, and an amount purchased of the bilateral fuel transaction amount according to a bilateral fuel contract is taken to be Gcont_LNG_buy.

$$\begin{matrix}Math . 12 & \\ Math . 12 Tank Fuel Heat Quantity Calculation Formula & \\ {H}_{tank\_LNG} ( t + 1 ) = \frac{A}{B} & Expression 25\end{matrix}$$

Note that,

A={Hₜₐₙₖ_{_}_{LNG}(t)×Gₜₐₙₖ_{_}_{LNG}(t)+H_{trade}_{_}_{LNG}(t)×G_{trade}_{_}_{LNG}_{_}_{buy}(t)+Hₛₕᵢₚ_{_}_{LNG}(t)×Gₛₕᵢₚ_{_}_{LNG}(t)+H_{cont}_{_}_{LNG}(t)×G_{cont}_{_}_{LNG}_{_}_{buy}(t)}

B={Gₜₐₙₖ_{_}_{LNG}(t)−G_{trade}_{_}_{LNG}(t)+Gₛₕᵢₚ(t)−G_{cont}_{_}_{LNG}_{_}_{buy}(t)}

Also, the amount of transaction in a fuel transaction market in each period is extracted from the transaction plan for a fuel transaction market, the tank volume and amount of fuel consumed in each period are extracted from the fuel tank operation plan, and a tank fuel unit price in each period is calculated from a bilateral fuel transaction amount according to a bilateral fuel contract, ship assignment plan, fuel market price, and initial tank fuel unit price stored in the database 205. A formula for calculating the tank fuel unit price can be expressed as in, for example, Expression 26.

$$\begin{matrix}Math . 13 & \\ Math . 13 Tank Fuel Unit Price Calculation \\ Formula & \\ {P}_{tank\_LNG} ( t + 1 ) = \frac{C}{D} & Expression 26\end{matrix}$$

Note that,

C={Pₜₐₙₖ_{_}_{LNG}(t)×Gₜₐₙₖ_{_}_{LNG}(t)+P_{trade}_{_}_{LNG}(t)×G_{trade}_{_}_{LNG}_{_}_{buy}(t)+Pₛₕᵢₚ_{_}_{LNG}(t)×Gₛₕᵢₚ_{_}_{LNG}(t)+P_{cont}_{_}_{LNG}(t)×G_{cont}_{_}_{LNG}_{_}_{buy}(t)}

D={Gₜₐₙₖ_{_}_{LNG}(t)−G_{trade}_{_}_{LNG}(t)+Gₛₕᵢₚ(t)−G_{cont}_{_}_{LNG}_{_}_{buy}(t)}

Also, a power generation revision amount in the power generating facility in each period is extracted from the power generation revision plan, the amount of fuel consumed for power generation revision in the power generating facility in each period is back calculated from the power generating characteristics of each power generating facility stored in the database 205, and a power generation revision fuel consumption plan is compiled.

The power generation revision fuel consumption plan calculated here added to the power generation fuel consumption plan calculated in step S2 is taken to be a fuel consumption restriction. A formula for calculating upper and lower limits of fuel consumption restriction can be expressed as in, for example, Expressions 27 and 28.

$$\begin{matrix} Math . 14 & \\ Math . 14 Fuel Consumption Restriction Upper \\ and Lower Limit Calculation Formula & \\ {G}_{cons\_LNG \_min} ( s ) = {\sum }_{t = {t}_{start ( s )}}^{{t}_{end} ( s )} \{ {G}_{gen\_LNG} ( t ) + {G}_{gen\_LNG \_plus} ( t ) \} - α & Expression 27 \\ {G}_{cons\_LNG \_max} ( s ) = {\sum }_{t = {t}_{start ( s )}}^{{t}_{end} ( s )} \{ {G}_{gen\_LNG} ( t ) + {G}_{gen\_LNG \_plus} ( t ) \} + β & Expression 28\end{matrix}$$

Next, in step S5, convergence of energy supply and demand plans is determined.

Specifically, the operation control unit 203 determines whether or not operations in the power supply and demand planning unit 206 and fuel supply and demand planning unit 207 have converged, ends the process flow by transmitting a command relating to ending operations when the operations have converged, and transmits a command relating to continuing operations when the operations have not converged, whereby step S1 is executed. Also, final and intermediate operation results may be output to the data output unit 202 at this point.

The operation control unit 203 determines that the operations have converged when the cumulative value of the transaction amount in a fuel transaction market in each period calculated in step 4 is equal to or less than the predetermined determination value 1 in the case of a first time, the cumulative value of the difference from the transaction amount in the fuel transaction market of the previous time is equal to or less than the determination value 1 in the case of a second time onward, and the cumulative value of the power generation revision amount in each period calculated in step S4 is equal to or less than the determination value 2. Herein, the determination value 1 and determination value 2 are taken to be values stored in the database 205.

A convergence determination formula 1 using the determination value 1 can be expressed as in, for example, Expression 29. Also, a convergence determination formula 2 using the determination value 2 can be expressed as in, for example, Expression 30.

$$\begin{matrix}Math . 15 & \\ Math . 15 Convergence Determination Formula 1 & \\ {\sum }_{t} \vert {G}_{trade\_LNG} ( t ) - {G}_{trade\_LNG \_pre} ( t ) \vert \leq {D}_{1} & Expression 29 \\ Convergence Determination Formula 2 & \\ {\sum }_{t} {E}_{LNG\_plus} ( t ) \leq {D}_{2} & Expression 30\end{matrix}$$

Convergence determination by the operation control unit 203 not being limited to this, convergence determination may be carried out using other values. For example, a total value of differences from previous values of a tank fuel unit price, tank fuel heat quantity, or the like, can be used in convergence determination.

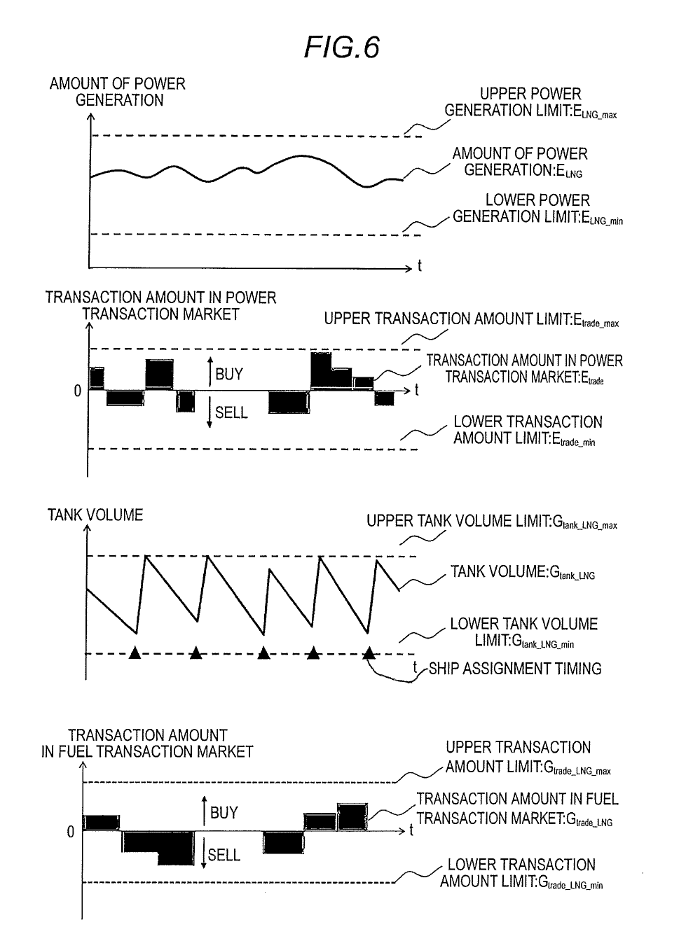

FIG. 6 is a diagram showing operation result output examples of the energy supply and demand planning device according to the first embodiment of the invention.

As data are mutually coordinated as heretofore described between the power supply and demand planning unit 206 and fuel supply and demand planning unit 207, which handle differing objective functions, energy supply and demand plans including transaction plans can be caused to converge, whereby an energy supply and demand plan that can be executed so as to maximize total profit can be obtained.

### Second Embodiment

In the first embodiment, a ship assignment plan is input into the database 205 before an operational processing is started, but in a second embodiment, a ship assignment plan compilation unit 209 that compiles a ship assignment plan from results calculated in the power supply and demand planning unit 206 is a component of the energy supply and demand planning device 2.

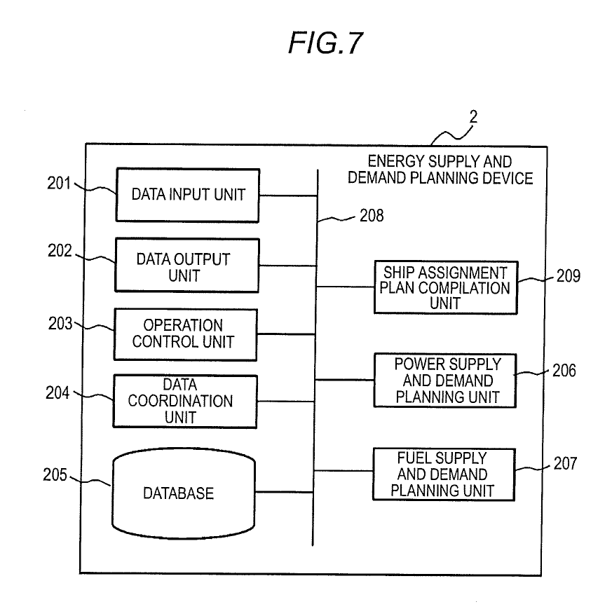

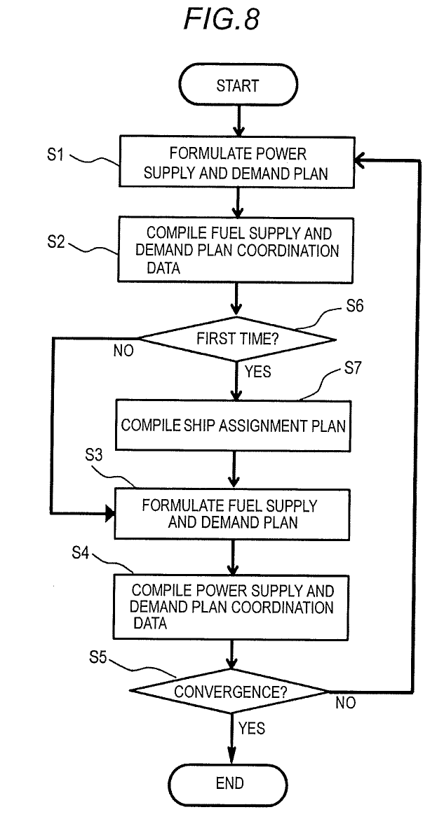

FIG. 7 is a functional block diagram of the energy supply and demand planning device 2 according to the second embodiment, and FIG. 8 is a flowchart showing an operational procedure that causes a compilation of an energy supply and demand plan according to the second embodiment to be executed.

In the drawings, it is assumed that the energy supplier introduces the energy supply and demand planning device 2, and formulates transaction plans for a power transaction market and fuel transaction market so that profit from an energy supply and demand plan is maximized. The energy supply and demand planning device 2 is configured of the data input unit 201, data output unit 202, operation control unit 203, data coordination unit 204, database 205, ship assignment plan compilation unit 209, power supply and demand planning unit 206, and fuel supply and demand planning unit 207, which are connected to each other by the communication system 208. As components other than the ship assignment plan compilation unit 209 are the same as in the first embodiment of the invention, the same reference signs are assigned thereto, and a description is omitted.

The ship assignment plan compilation unit 209 is a function that carries out compilation of a ship assignment plan necessary for an energy supply and demand plan, includes, for example, a CPU and DRAM, receives a command from the operation control unit 203 after a first processing in the power supply and demand planning unit 206 and data coordination unit 204, and compiles a ship assignment plan so as not to extend beyond upper and lower tank volume limits from a power generation fuel consumption plan calculated in the data coordination unit 204. The ship assignment plan compiled here is stored in the database 205.

FIG. 8 is a flowchart showing a process procedure that a computer is caused to execute.

In the drawing, steps other than steps S6 and S7 are the same as in the flowchart of the first embodiment, because of which a description thereof is omitted.

After fuel supply and demand plan coordination data are compiled in step S2, it is determined in step S6 whether or not this is a first operation.

Specifically, when the number of operation repetitions managed by the operation control unit 203 is 1, that is, in the case of a first operation, the process shifts to step S7, and when the number of operation repetitions is 2 or more, that is, in the case of a second operation onward, the process shifts to step S3 without passing through step S7.

In step S7, a ship assignment plan is compiled.

Specifically, an amount of fuel consumed in power generation in each period is extracted from the power generation fuel consumption plan calculated in the data coordination unit 204 in step S2, and a ship assignment timing and supply quantity are calculated from the initial tank volume, final tank volume, and upper and lower tank volume limits stored in the database 205. A heat quantity and unit price of fuel supplied in advance are set for each ship assignment based on information in a long-term fuel purchasing plan to which the energy supplier is contracted, and the like. Ship assignment timings are determined sequentially from the start of a period in which an operation is carried out. That is, with the initial tank volume as a reference, a plan is formulated so that amounts of fuel consumed in power generation are subtracted sequentially in temporal sequence from an earlier period, and a ship is assigned before the tank volume drops below the lower tank volume limit. The tank volume increases after the ship assignment, but in the same way, a plan is formulated so that amounts of fuel consumed in power generation are subtracted sequentially in temporal sequence, and a ship is assigned before the tank volume drops below the lower tank volume limit. In this way, ship assignment is planned until the point at which the period in which an operation is carried out ends, and the compiled ship assignment plan, that is, a supply amount, heat quantity, and price in each period of fuel conveyed by fuel tanker, is stored in the database 205.

A ship assignment plan compilation method of the ship assignment plan compilation unit 209 not being limited to this, a ship assignment plan may be compiled using another method, such as planning ship assignment so that the tank volume is as near as possible to an intermediate value of the upper and lower tank volume limits.

According to the second embodiment, as heretofore described, the configuration is such that a ship assignment plan is compiled in the ship assignment plan compilation unit 209, because of which, even when no ship assignment plan has been decided upon, the same advantages as in the first embodiment can be obtained by compiling a ship assignment plan.

Each embodiment can be modified or omitted as appropriate, without departing from the scope of the invention.

Various modifications and alterations of this invention will be apparent to those skilled in the art without departing from the scope and spirit of the invention, and it should be understood that this is not limited to the illustrative embodiments set forth herein.

1. An energy supply and demand planning device that formulates a power supply and demand plan and a fuel supply and demand plan, the energy supply and demand planning device comprising:
a database in which are stored data necessary for a power supply and demand plan and a fuel supply and demand plan;
a power supply and demand planning unit that formulates a transaction plan for a power transaction market and a power generation plan;
a fuel supply and demand planning unit that formulates a transaction plan for a fuel transaction market, a power generation revision plan, and a fuel tank operation plan;
a data coordination unit that carries out an exchange of data between the power supply and demand planning unit and fuel supply and demand planning unit; and
an operation control unit that carries out a determination of a start and convergence of operations in the power supply and demand planning unit and fuel supply and demand planning unit.

2. The energy supply and demand planning device according to claim 1, comprising a ship assignment plan compilation unit that compiles a ship assignment plan from a power generation fuel consumption plan calculated from a result output by the power supply and demand planning unit.

3. A non-transitory computer-readable medium having stored thereon an energy supply and demand planning program that causes a computer to execute:
a power supply and demand planning process of formulating a transaction plan for a power transaction market and a power generation plan;
a fuel supply and demand planning process of formulating a transaction plan for a fuel transaction market, a power generation revision plan, and a fuel tank operation plan;
a data coordinating process of exchanging data between the power supply and demand planning process and fuel supply and demand planning process; and
an operation control process of carrying out a determination of a start and convergence of operations in the power supply and demand planning process and fuel supply and demand planning process.
